(19) United States
(12) Patent Application Publication
(10) Pub. No.: US 2009/0173588 A1
(43) Pub. Date: Jul. 9, 2009

(54) VIBRATION DAMPER NOTABLY FOR AN AEROSPACE STRUCTURE

(75) Inventors: Carole GELBARD, Colombes (FR); Thibaut Buffin, Levallois-Perret (FR)

Correspondence Address: OBLON, SPIVAK, MCCLELLAND MAIER & NEUSTADT, P.C., 1940 DUKE STREET, ALEXANDRIA, VA, 22314, US

(73) Assignee: HUTCHINSON, PARIS (FR)

(21) Appl. No.: 12/345,126

(22) Filed: Dec. 29, 2008

(30) Foreign Application Priority Data
Jan. 3, 2008 (FR) 08 00036

(51) Int. Cl. F16F 9/06

(52) U.S. Cl. 188/269

(57) ABSTRACT

The invention relates to a vibration damper characterized in that it includes:
a casing (10) delimiting an annular chamber (11)
a piston (1) having a central ring (2) sliding in the annular chamber (11), which has an external contour of diameter greater than or substantially equal to the outside diameter of the central ring (2) so that the annular chamber (11) is divided into a first compartment (11₁) and a second compartment (11₂),
two assembly elements disposed at the opposite ends of the piston, a first assembly element (6) being attached to the casing (10) and a second assembly element (7) being attached to the piston (1),
at least one of said compartments (11₁, 11₂) including at least one knitted wire metal cushion,
a damping fluid filling the annular chamber (11), including the interstices between the meshes of the metal cushion(s) (21, 22).

The present invention concerns a vibration damper, notably for an aerospace structure.

All-metal dampers are known already, but they do not offer sufficient damping or it is not possible to obtain a high stiffness within a small volume.

Elastomer dampers are also known, but on the one hand they do not offer sufficient damping and on the other hand it is not possible to obtain a high stiffness within a small overall size, and they are moreover temperature-sensitive.

Further known are combined spring and hydraulic dampers, but it is not possible to obtain a high stiffness within a small volume.

Finally, none of these systems enables independent adjustment of stiffness and damping.

The invention therefore aims to provide a vibration damper that does not have at least one of the drawbacks referred to above.

The invention thus consists in a vibration damper characterized in that it includes:
a casing delimiting an annular chamber,
a piston having a central ring sliding in the annular chamber. This annular chamber has an external contour of diameter greater than or substantially equal to the outside diameter of the central ring so that it is divided into a first compartment and a second compartment,
two assembly elements disposed at the opposite ends of the piston, a first assembly element being attached to the casing and a second assembly element being attached to the piston,
at least one of said compartments including at least one knitted wire metal cushion,
a damping fluid filling the annular chamber, including the interstices between the meshes of the metal cushions.

The central ring has at least one hole through it and/or a clearance at its periphery for the damping fluid to pass through during axial movements of the piston.

The stiffness of the damper is provided by the metal cushions, while for the most part the damping is produced by dissipation of energy of the fluid passing on the one hand through the meshes of the knitted wire of the metal cushions and on the other hand via the clearance between the central ring of the piston and the external contour of the annular chamber and/or the hole(s) through the central ring of the piston.

The assembly element(s) can be a ball joint, notably of metal or an elastomer/metal laminate.

The metal cushions advantageously have in the unstressed state an inside diameter d between 10 mm and 25 mm, an outside diameter D between 30 mm and 50 mm, and a height H between 10 mm and 20 mm.

The metal cushions are advantageously prestressed axially, notably with a prestressing ΔH/H, where ΔH designates the crushing of the cushion resulting from the prestressing, which is between 10% and 50%.

The relative density of the metal cushions is advantageously between 0.2 and 3.

The damper preferably includes at least one compensation chamber providing on the one hand compensation of the contraction and the expansion of the fluid, respectively cold and hot, and on the other hand pressurization of the fluid by means of an elastic member.

Other features and advantages of the invention will become more clearly apparent on reading the following description, with reference to the drawings, in which:

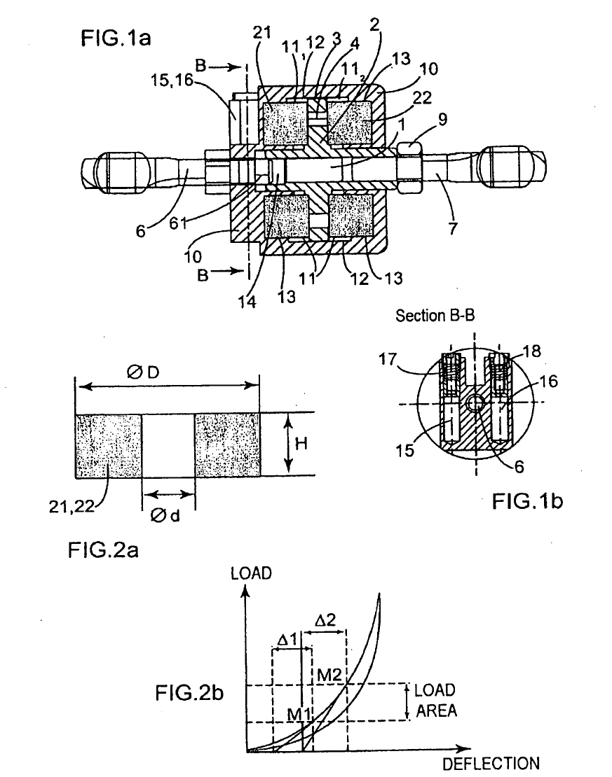

FIG. 1a is an overall diagram in axial section of a damper intended for an aerospace application, FIG. 1b being a section taken along the line BB in FIG. 1a, showing the compensation chambers,

FIG. 2a represents a metal cushion in axial section and FIG. 2b represents a typical stiffness curve of a metal cushion under axial load,

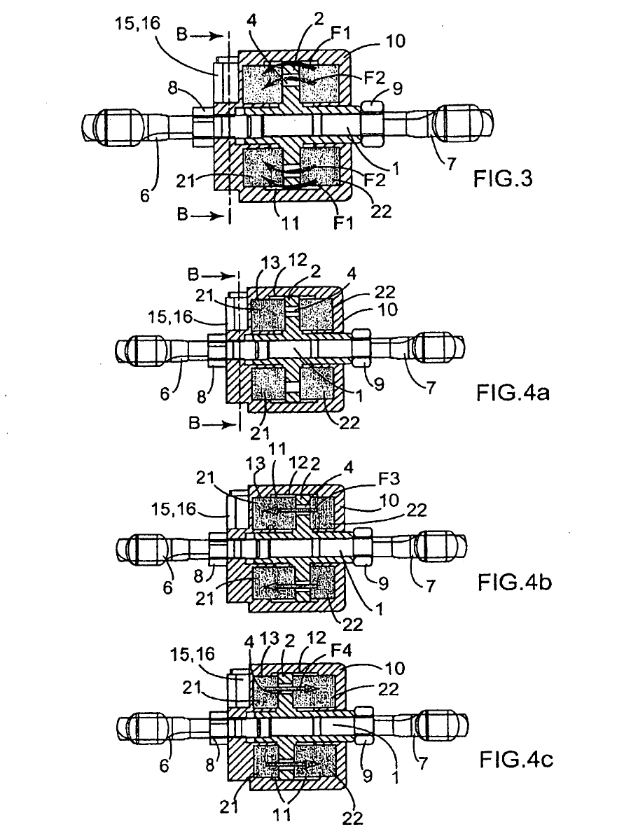

FIG. 3 illustrates the circulation of the fluid in the damper,

FIGS. 4a to 4c illustrate the operation of the device in three positions, respectively a balanced position on fitting it (FIG. 4a), a right-hand abutment position (FIG. 4b), and a left-hand abutment position (FIG. 4c).

The invention concerns a damper that can be fitted to any structure or equipment that must be protected against vibrations. The damper is mounted on an aerospace structure, but can be applied to a helicopter rotor, an automobile vehicle engine, a vibrating machine, etc.

It is more particularly a question of a mechanical connection with elastic and dissipative compartment the damping and the stiffness of which can be adjusted independently. The technique used combines metal cushion(s) and fluid damping.

The damper represented by way of example in FIG. 1a has a piston 1 provided with a central ring 2 having an external contour 3 of diameter D₀ sliding, possibly with clearance, in the external contour 12 of an annular chamber 11 of a casing 10 in which the piston 1 slides, so that the annular chamber 11 is separated into a first compartment 11₁ and a second compartment 11₂. The external contour of the annular chamber here includes a first cylindrical external contour 13 of diameter substantially equal to D to house metal cushions 21 and 22 and the cylindrical external contour 12 of diameter D₀ to enable sliding of the external contour of the central ring 2, possibly with a calibrated clearance enabling damping by flow of the fluid.

FIG. 1b shows two compensation chambers 15 and 16 situated on respective opposite sides of the ball joint 6, and provided with spring pressurization devices 17 and 18. It will be noted that it is possible to provide a compensation device within a space of the annular chamber 11.

Bolts 8 and 9 are used to fix the left-hand ball joint 6 and the right-hand ball joint 7.

The left-hand ball joint 6 is fixed by the bolt 8 to the casing 10 while the right-hand ball joint 7 is attached to the piston 1 to which it is fixed by the bolt 9. The cylindrical end 61 of the left-hand ball joint 6 slides in a cylindrical aperture 14 of the piston 1.

The stiffness (return force) function is produced by the metal cushions 21 and 22 while the damping is produced by dissipation of energy resulting for the most part from the flow of the fluid through the meshes of the metal cushions 21 and 22.

The axial prestressing ΔH/H is between 10% and 50%, for example.

FIG. 3 illustrates the circulation of the fluid in the damper during axial displacement of the piston 1:
via the holes 4 through the central ring 2 of the piston 1 (arrows F₂), and/or
via the external clearance between the central ring 2 and the casing 10 (arrows F₁).

The vibration damper has a number of functions:
The assembly to the structure to be damped is provided by two ball joints 6, 7 which can be either dry ball joints (metal) or elastic ball joints (rubber/metal).

Using a rubber/metal laminate ball joint eliminates damage through metal/metal contact. Any damage to the laminated ball joints is furthermore easier to detect and measure.
The stiffness function of the damper system is localized in the casing 10 between two ball joints 6 and 7. It is obtained by an assembly of metal cushions 21 and 22 mounted in opposition and prestressed on respective opposite sides of the central ring 2 of the piston 1 that slides in the casing 10.

The metal cushions 21 and 22 consist of stainless wire knitted, embossed and then shaped in a press. In particular they integrate a progressive abutment effect as a result of the increase in the static stiffness as a function of the degree of crushing. The wire is insensitive to temperatures (−70° C. to +300° C. for a stainless steel wire and up to +650° C. for a refractory stainless wire) and to chemical products. It introduces a high stiffness within a small overall size.

The wire has a diameter between 0.05 mm and 0.4 mm, for example.

The relative density of a metal cushion is between 0.2 and 3, for example.

The metal cushions have diverse shapes. In the design shown, metal cushions 21 and 22 of annular shape are used. The typical stiffness curve of this kind of metal cushion is generally as shown in FIG. 2b. It is highly non-linear. M1 designates the load corresponding to the prestressing and M2 the load corresponding to the maximum loading.

For the envisaged application, the stiffness provided by the metal cushions varies from 0 (cushion not prestressed) to approximately 10 000 N/mm (maximum load). The range of dynamic relative movement is 0-2 mm to either side of the rest position, for example.
The energy dissipation function of the damper system is produced:
   by passage of the fluid through the meshes of the metal cushions 21 and 22,
   by passage of the fluid through the holes 4 in the ring 2 of the central piston 1,
   by the fibers of the metal cushions 21 and 22 rubbing against each other,
   by the fibers of the metal cushions 21 and 22 rubbing on the casing 10 and the piston 1.

The damping effect of a metal cushion alone (loss factor tan δ) is of the order of 10 to 30% as a function of its fabrication parameters and its confinement after integration. The fluid flowing through the meshes of the metal cushions 21 and 22 and the holes 4 in the central piston during movement introduces a greater head loss and increases this damping effect.

In the envisaged application, between 0 and 50 Hz, and for amplitudes between ±0.2 and ±2 mm, the loss factor tan(δ) varies between 0.5 and 2.

Thus the damper includes metal cushions bathed in a fluid, which can be silicone oil, water containing glycol or any other fluid compatible with the conditions of use of the damper system. The relative density of the metal cushions and the viscosity of the fluid can be adjusted as a function of the damping performance to be achieved and compatibility with high and low temperatures.

The fluid occupies the whole of the volume of the chamber constituting the damper system:
interstices between the metal cushions 21 and 22 and the piston 1,
interstices between the metal cushions 21 and 22 and the casing 10,
interstices between the meshes of the metal cushions 21 and 22,
holes 4 of the central piston,
compensation chambers 15 and 16.

The piston 1 that enables movement and therefore passage of the fluid from one compartment 1 to the other 1112 includes bores 4 enabling the fluid to flow from one compartment to the other.

This flow can also be obtained by creating a flow cylinder between the exterior contour 3 of the central ring 2 of the piston and the inside diameter 12 of the cavity 11 of the casing 10.

It will be noted that the loss factor and the stiffness of the system depend on:
the frequency,
the dynamic amplitude,
the stiffness of the metal cushions,
the viscosity of the fluid (in the envisaged application: 0 to 10 000 CTS),
the temperature of use (in the envisaged application: −50° C. to 200° C.).

A compensation and pressurization system 15, 16 enables the damper to operate over a wide temperature range with the same efficacy.

The compensation system consists here of two interconnected chambers 15 and 16 communicating with the interior chamber 11 of the casing 10. The volume to be compensated is a function of the volume of fluid in the damper, the temperature range of use and the coefficient of expansion of the fluid. In each chamber 15, 16, a spring 17, 18 pressurizes the fluid. The number and the volume of the chambers can vary according to the application.

The system is sealed by seals preventing leakage of the fluid at the connectors or by rolling membranes (rubber reinforced with a textile braid).

The system is filled with the fluid via a sealed filler plug.

The piston 1 can move axially, from its high position (right-hand abutment position) to its low position (left-hand abutment position).

FIGS. 4a to 4c explain these movements. The movement of the piston leads to a variation in the volume of fluid in the two compartments. Flow through the meshes of the metal cushions 21 and 22 and the bores 4 of the piston produces a head loss resulting in the damping effect.

FIG. 4a shows the damper in a balanced position when fitting it. The prestressing of the metal cushions 21 and 22 provides a return action toward this position.

FIG. 4b shows the piston 1 reaching the right-hand abutment position (high position), the arrow F₃ indicating the direction of displacement of the fluid during movement toward the right-hand abutment.

FIG. 4c shows the piston 1 reaching the left-hand abutment position (low position), the arrow F₄ indicating the direction of displacement of the fluid. In this position, the bolt 9 abuts against the casing 10 and the cylindrical region 14 is engaged as far as possible in the end 61 of the ball joint 6.

The damper of the invention is intended to reduce the dynamic forces on the structure of a machine when operating. This machine can be:
an aerospace engine; the damper is then placed between structural elements in dynamic motion relative to each other, and the object is to reduce the stresses where these elements are built in;
a helicopter rotor; the damper is placed between two blade sleeves, or between the hub of the rotor and the blade sleeve; the object is to reduce the movement of one blade relative to the other, notably drag movement.

The damper can also be intended to reduce the transmission of vibrations coming from:
a vibrating machine in an industrial establishment of compressor, grinder, generator set, motorized fan, etc. type; the aim is then to isolate the machine from the ground, to protect persons and equipment around the source machine;
an automobile vehicle, bus, heavy goods vehicle engine; the aim is then to isolate the floor and to improve the comfort of passengers or to protect the rest of the equipment of the vehicle;
equipment or a motor on a train or a ship; the aim is then to isolate the floor and to improve the comfort of passengers, or to protect the rest of the equipment of the train or the ship.

The damper can also be intended to isolate from external vibrations equipment that is fragile or dedicated to precise measurements, for example:
control or detection equipment,
optical or optronic equipment,
computer equipment.

This system can be used under other conditions and in any other application necessitating damping of vibrations.

1. Vibration damper, characterized in that it includes:
a casing (10) delimiting an annular chamber (11)
a piston (1) having a central ring (2) sliding in the annular chamber (11), which has an external contour of diameter greater than or substantially equal to the outside diameter of the central ring (2) so that the annular chamber (11) is divided into a first compartment (11₁) and a second compartment (11₂),
two assembly elements disposed at the opposite ends of the piston, a first assembly element (6) being attached to the casing (10) and a second assembly element (7) being attached to the piston (1),
said compartments (11₁, 11₂) each being filled by at least one knitted wire metal cushion (21, 22), these elements constituting the damping elements of the damper,
a damping fluid filling the annular chamber (11), including the interstices between the meshes of the metal cushion(s) (21, 22).

2. Vibration damper according to claim 1, characterized in that the central ring (2) has at least one hole (4) through it for the damping fluid to pass through.

3. Vibration damper according to one of claims 1 or 2, characterized in that at least one assembly element is a ball joint (6, 7).

4. Vibration damper according to claim 3, characterized in that said ball joint (6, 7) is a metal ball joint.

5. Vibration damper according to claim 3, characterized in that said ball joint (6, 7) is a laminated ball joint.

6. Vibration damper according to one of the preceding claims, characterized in that the metal cushions (21, 22) have in the unstressed state an inside diameter d between 10 mm and 25 mm, an outside diameter D between 30 mm and 50 mm, and a height H between 10 mm and 20 mm.

7. Vibration damper according to one of the preceding claims, characterized in that the metal cushions (21, 22) are prestressed axially.

8. Vibration damper according to claim 7, characterized in that the prestressing ΔH/H, where ΔH designates the crushing of the metal cushion(s) (21, 22) resulting from the prestressing, is between 10% and 50%.

9. Vibration damper according to one of the preceding claims, characterized in that the knitted wire has a diameter between 0.05 mm and 0.4 mm.

10. Vibration damper according to one of the preceding claims, characterized in that the relative density of the metal cushion(s) (21, 22) is between 0.2 and 3.

11. Vibration damper according to one of the preceding claims, characterized in that the damping fluid is silicone oil.

12. Vibration damper according to one of claims 1 to 10, characterized in that the damping fluid is water containing glycol.

13. Vibration damper according to one of the preceding claims, characterized in that it includes at least one compensation chamber (15, 16) for pressurizing the fluid by means of an elastic element (17, 18).
